(19) United States
(12) Patent Application Publication
(10) Pub. No.: US 2026/0058502 A1
(43) Pub. Date: Feb. 26, 2026

(54) METHOD FOR OPERATING A SYSTEM WITH A PARKING LOT AND AT LEAST ONE MOTOR VEHICLE

(71) Applicant: MAHLE International GmbH, Stuttgart (DE)

(72) Inventor: Mike Boettigheimer, Kornwestheim (DE)

(21) Appl. No.: 19/104,204

(22) PCT Filed: Jun. 1, 2023
(86) PCT No.: PCT/EP2023/064666

§ 371 Date: Feb. 14, 2025

(30) Foreign Application Priority Data
Aug. 16, 2022 (DE) 10 2022 120 700.5
Sep. 28, 2022 (DE) 10 2022 125 040.7

(51) Int. Cl. H02J 50/90; B60L 53/126; B60L 53/35; G01C 21/20; H01F 38/14; H02J 50/10; H02J 50/40

(52) U.S. Cl. CPC H02J 50/90; G01C 21/20; H01F 38/14; H02J 50/10; H02J 50/40; B60L 53/126; B60L 53/35

(57) ABSTRACT

A motor vehicle including a mobile induction charging device is disclosed. The motor vehicle is configured to: receive alignment fields generated by stationary induction charging devices of parking spaces of a parking lot and to detect the signal strength and alignment frequency of the alignment fields, recognize based on a stronger alignment field and the alignment frequency of the stronger alignment field that the mobile induction charging device is to be aligned with the stationary induction charging device associated with the parking space as it approaches one of the parking spaces, and output a navigation instruction for aligning the motor vehicle on the parking space via the alignment field associated with the approached parking space.

### CROSS-REFERENCE TO RELATED APPLICATIONS

This application claims priority to International Patent Application No. PCT/EP2023/064666 filed Jun. 1, 2023, which also claims priority to German Patent Application DE 10 2022 125 040.7 filed Sep. 28, 2022 and German Patent Application DE 10 2022 120 700.5 filed Aug. 16, 2022, the contents of each of which is hereby incorporated by reference in its entirety.

### TECHNICAL FIELD

The present invention relates to a method for operating a system with a parking lot comprising a plurality of parking spaces, as well as with a motor vehicle, wherein stationary induction charging devices of the parking spaces interact with mobile induction charging devices of the motor vehicles for wireless energy transfer. The invention further relates to such a system.

### BACKGROUND

A stationary induction charging device that cooperates with a mobile induction charging device of the motor vehicle is usually used for wireless energy transfer with a motor vehicle. For wireless energy transfer, an energy coil of one of the induction charging devices acts as a primary coil and the energy coil of the other induction charging device acts as a secondary coil. For energy transfer, the primary coil generates an alternating magnetic field that induces a voltage in the secondary coil. To enable wireless energy transfer and to increase the efficiency of energy transfer, the primary coil and the secondary coil, and thus the energy coils of the induction charging devices, are positioned relative to each other accordingly.

A parking lot usually comprises several parking spaces. It is conceivable to provide each of the parking spaces with a stationary induction charging device such that the respective parking space can cooperate with the mobile induction charging device of respectively one motor vehicle for energy transfer. In this case, the stationary induction charging device of the respective parking space must be accordingly positioned with respect to one another with the associated mobile induction charging device of a motor vehicle parked on the parking space in order to permit energy transfer and to increase efficiency. The positioning can theoretically occur when a motor vehicle drives onto the parking space operated either by the driver, or at least partially autonomously. However, this has the disadvantage that there is no reliable and/or precise positioning of the induction charging devices relative to one another, in which case energy is either not transferred or is only transferred with reduced efficiency. It is therefore desirable to position the motor vehicle on the parking space and thus position the induction charging devices relative to one another in a controlled manner. For this purpose, it is conceivable that the parking space and the motor vehicle communicate with one another.

DE 10 2017 202 966 A1 describes a system with a parking lot and at least one motor vehicle. The parking spaces of the parking lot are equipped with occupancy sensors. The motor vehicle is notified of the occupancy status of the respective parking space.

The present invention deals with the task of providing a method of the aforementioned type for operating a system with a parking lot and at least one motor vehicle and to provide improved or at least different embodiments for such a system that in particular eliminate disadvantages from the prior art. In particular, the present invention deals with the task of providing improved or at least alternative embodiments for the method and for the system, which are characterized by a reliable and more precise positioning of motor vehicles on parking spaces and by increased efficiency of the wireless energy transfer.

According to the invention, this task is solved by the subject matter of the independent claim(s). Preferred embodiments are the subject matter of the dependent claims.

### SUMMARY

The present invention is therefore based on the general idea to provide parking spaces of the parking lot-in a system comprising a parking space and at least one motor vehicle-with stationary induction charging devices, which, when in operation, generate a directed field for aligning a motor vehicle relative to the associated parking space and thus relative to the stationary induction charging device, wherein at least two of the adjacent mobile induction charging devices generate the field with different frequencies, and wherein the motor vehicle receives the fields and recognizes the local intensity and thus the signal strength as well as the frequency. Thus, when approaching a parking space, the motor vehicle can, by virtue of the closer arrangement to the approached parking space and by virtue of the higher intensity and higher frequency associated with the higher intensity, clearly recognize which parking space and thus which stationary induction charging device to use for wireless, inductive energy transfer with a mobile induction charging device of the motor vehicle, thus ensuring reliable navigation of the motor vehicle to the approached parking space and optimal alignment and positioning of the induction charging devices relative to one another. As a result, motor vehicles are reliably and accurately positioned on parking spaces in the parking lot, thus achieving improved energy transfer between the induction charging devices and also increased efficiency.

In particular, the inventive method does not require determining in advance on which parking space and thus on which stationary induction charging device the motor vehicle has to position itself, and a driver is also not required to select this manually. The method, in particular a corresponding computer program product, instead automatically detects the strongest received signal and thus the highest local intensity, and can distinguish this correctly by virtue of the different frequency from the neighboring parking spaces, and thus positions correctly.

According to the idea of the invention, the method is used for operating the system with the parking lot and at least one motor vehicle. The parking lot has at least four parking spaces, preferably a plurality of parking areas. The respective parking space is provided with a stationary induction charging device that cooperates with a mobile induction charging device of a motor vehicle for inductive wireless energy transfer. The respective parking space can be driven into in one direction, which is hereinafter also referred to as the parking direction. At least two of the parking spaces, preferably the respective parking space, are arranged in a row oriented parallel to the parking direction, wherein the row is hereinafter also referred to as a lengthwise row. At least two of the parking spaces, preferably the respective parking space, are arranged in a row running transversely to the parking direction, wherein the row is hereinafter also referred to as a transverse row. In order to align the mobile induction charging device in relation to the stationary induction charging device, the respective stationary induction charging device generates a field directed in parking direction, which is hereinafter also referred to as alignment field. The property of the alignment field directed in parking direction means that the field lines of the alignment field propagate with greater intensity in the parking direction and with lower intensity transverse to the parking direction. The respective alignment field is thus stronger along the associated lengthwise row than along the associated transverse row. Furthermore, the induction charging devices of the parking spaces of at least one of the transverse rows alternately generate the alignment field with a first frequency and a second frequency, which are hereinafter also referred to as the first alignment frequency and the second alignment frequency. The respective motor vehicle receives the alignment fields such that the motor vehicle recognizes the local signal strength and frequency of the alignment fields. When a parking space is approached, the stronger alignment field and the alignment frequency of the stronger alignment field permits recognizing that the mobile induction charging device must be aligned with the induction charging device associated with the parking space. A navigation instruction for aligning the motor vehicle on the parking space is then generated using the alignment field associated with the approached parking space.

It is expedient to generate at least two of the alignment fields, preferably the respective alignment field, with the same signal strength and thus intensity.

Alignment is herein understood to mean in particular driving the motor vehicle onto the parking space and thus in particular approaching the stationary induction charging device with the mobile induction charging device and the correct angular positioning.

The parking direction is expediently oriented parallel or along the lengthwise orientation of the associated parking space.

A parking space is usually approached when the motor vehicle moves in the direction of the parking space. Navigation by means of the navigation instruction can in particular begin when the motor vehicle has reached an outer edge of the parking space and/or of the stationary induction charging device.

The induction charging devices are advantageously spaced apart. The stationary induction charging devices of the respective transverse row and the respective lengthwise row are in particular spaced apart from one another.

It is conceivable that at least two parking spaces of at least one of the transverse rows touch each other directly, in particular transition directly into each other.

It is conceivable that a traveling lane runs between at least two of the lengthwise rows. It is conceivable that at least two parking spaces of at least one of the transverse rows are spaced apart immediately in relation to one another, i.e. no traveling lane is located between the parking spaces.

In advantageous embodiments, the stationary induction charging devices of the respective transverse rows alternately generate the alignment field with the first alignment frequency and the second alignment frequency. The stationary induction charging devices of the parking spaces of the lengthwise rows thus preferably generate the alignment field with the same alignment frequency.

The parking lot can comprise at least three such transverse rows and at least two such lengthwise rows.

It is preferred that the stationary induction charging devices of the parking spaces generate the alignment field along the transverse rows and along the lengthwise rows each with alternating alignment frequency such that the stationary induction charging devices of the parking spaces alternately generate the alignment field in one of the transverse rows with a first alignment frequency and a second alignment frequency, and such that the stationary induction charging devices of the parking spaces alternately generate the alignment field in the respectively adjacent transverse row with a third alignment frequency and a fourth alignment frequency. The stationary induction charging devices of one of the transverse rows thus generate the alignment fields with a first sequence with alternating first alignment frequency and second alignment frequency and the stationary induction charging devices of the respectively adjacent transverse row generate the alignment fields with a second sequence by alternating the third alignment frequency and the fourth alignment frequency, wherein the first sequence and the second sequences alternate in sequentially arranged transverse rows. This is preferably done such that the stationary induction charging devices of the parking spaces in the respective lengthwise row generate the alignment field either by alternating the first alignment frequency and the third alignment frequency or by alternating the second alignment frequency and the fourth alignment frequency. The respective stationary induction charging device thus generates the associated alignment field with an alignment frequency that differs from the alignment frequencies of the respectively directly adjacent mobile stationary induction charging devices. As a result, the motor vehicle, in particular the respective mobile induction charging device, is able to more easily differentiate the stationary induction charging devices, thus achieving more reliable and precise positioning of motor vehicles on parking spaces of the parking lot and thus further increasing efficiency.

The respective alignment field can in principle be of any type.

In preferred embodiments, the respective alignment field is a magnetic field, in particular an alternating magnetic field. This means that the respective mobile induction charging device generates a magnetic alignment field. This results in a simple generation of the alignment field, wherein the alignment field can be received in a simplified manner by the motor vehicle and is stable.

To generate the magnetic alignment field, the respective induction charging device can comprise a corresponding coil, which is hereinafter also referred to as alignment coil. The alignment coil is advantageously wound about a winding axis oriented parallel to the parking direction.

Embodiments are preferred if at least one of the alignment fields propagates along the associated parking direction starting from the associated stationary induction charging device, in particular from the associated alignment coil. In particular, this can be only a minor propagation, which therefore results in the alignment fields spreading apart with increasing distance from their source, namely the alignment coil. The effect is that a motor vehicle receives the alignment field even if it approaches the associated parking space at an angle or at an angle to the parking direction and does not, or not only, receive the alignment field of the adjacent stationary induction charging device. The alignment or output of the navigation instruction can then also be carried out reliably in the event of such an approach.

The respective alignment field preferably propagates starting from the associated stationary induction charging device, in particular from the associated alignment coil, along the associated parking direction.

In preferred embodiments, the respective alignment field is used for far positioning of a mobile induction charging device in relation to the stationary induction charging device associated with the approached parking space. The far positioning preferably occurs at distances between the induction charging devices greater than 0.5 m, in particular greater than 1.5 m. Far field positioning thus represents a rough positioning of the induction charging devices relative to one another.

In preferred embodiments, the respective stationary induction charging device also generates a field that is directed parallel to the normal of the plane of the associated parking space, in particular from the plane of the associated parking space, and is hereinafter also referred to as a positioning field. This means in particular that the positioning field is directed in the height direction. The respective motor vehicle can receive the positioning field. This means in particular that the respective motor vehicle recognizes the local intensity of the positioning field. A navigation instruction for positioning the mobile induction charging device of the motor vehicle in relation to the stationary induction charging device of the approached parking space is output by means of the positioning field.

The positioning of the induction charging devices in relation to one another advantageously not only serves the purpose of achieving an approach of the induction charging device in relation to one another, but also of aligning these in relation to one another in the plane of the parking space.

It is preferred if a near-positioning of the mobile induction charging device in relation to the induction charging device associated with the approached parking space is achieved by means of the positioning field. In particular in comparison to far positioning, near positioning is understood to mean a more precise positioning of the induction charging devices in relation to one another.

Preferably, near positioning occurs following far positioning. Near positioning thus begins in particular at distances between the induction charging devices of less than 0.5 m, in particular less than 0.3 m.

The respective stationary induction charging device preferably generates the positioning field with four or five coils spaced apart from one another that each generate one magnetic field. This means that the positioning field consists of four or five magnetic fields offset in relation to one another. The different magnetic fields of the positioning field can thus be used to position the induction charging devices in at least two directions oriented transversely in relation to one another, in particular in the parking direction and transversely to the parking direction. This leads to more precise and simpler positioning of the induction charging devices in relation to one another and consequently also to increased efficiency.

In preferred embodiments, the magnetic fields, or magnetic fields of the positioning field, are each generated with an associated frequency, which is hereinafter also referred to as positioning frequency. If a positioning field thus comprises four magnetic fields, one of the magnetic fields is generated with a first positioning frequency, one of the magnetic fields with a second positioning frequency, one of the magnetic fields with a third positioning frequency, and one of the magnetic fields with a fourth positioning frequency. If the positioning field comprises five magnetic fields, they are each generated with an associated positioning frequency, i.e. a magnetic field with a first positioning frequency, a magnetic field with a second positioning frequency, a magnetic field with a third positioning frequency, a magnetic field with a fourth positioning frequency, and a magnetic field with a fifth positioning frequency. The motor vehicle, in particular the mobile induction charging device, can distinguish the positioning frequencies from one another. This results in a simple and reliable positioning of the induction charging devices in relation to one another.

In order to generate the respective magnetic field, the induction charging device that generates the magnetic fields of the positioning field preferably comprises an associated coil, preferably a flat coil that is preferably wound in the plane, or parallel to the plane, of the associated parking space and/or about a winding axis oriented parallel to the normal of the parking space. The magnetic fields of the positioning field are thus directionally radiated upwards. This has the consequence in particular that the positioning is more precise by means of the positioning field, and that there is low interaction and/or overlapping of the positioning field with the alignment field. This achieves improved and more reliable and more robust positioning of the induction charging devices in relation to one another, or of the motor vehicle on the respective parking space.

The positioning is preferably carried out by means of the magnetic fields of the positioning field in that a ratio is formed between two of the magnetic fields and the navigation instruction is output on the basis of the ratio. This leads to a robust implementation of the navigation with increased reliability.

The respective navigation instruction can be made available to a driver who drives, in particular steers, the motor vehicle according to the navigation instruction in order to achieve alignment. Alternatively or additionally, the respective navigation instruction can be output to a driver assistance system for at least partially autonomous driving of the motor vehicle. The driver assistance system can then at least partially drive the motor vehicle autonomously by means of the navigation instruction.

In preferred embodiments, the respective positioning frequency differs from the respective alignment frequency of the respective alignment field. This results in an improved transition between far positioning and near positioning and/or there is thus no negative influence between the far positioning and the near positioning.

It is further preferred if the magnetic fields of the positioning field of the respective stationary induction charging device are generated with the same positioning frequencies. The system thus requires a reduced total number of frequencies or a smaller frequency band.

The respective frequency is preferably in the kilohertz range.

As mentioned above, it is preferred for the frequencies to differ from each other. In particular, it is conceivable that adjacent frequencies in the frequency band differ from one another by 0.4 kHz to 1 kHz.

The first alignment frequency is advantageously 134.0 kHz or 135.0 kHz or 145.560 kHz.

The second alignment frequency is advantageously 135.5 kHz or 136.5 kHz or 137.0 kHz or 145.985 kHz.

The third alignment frequency is advantageously 133.5 kHz or 146.843 kHz.

The fourth alignment frequency is advantageously 137.0 kHz or 137.5 kHz or 147.275 kHz.

The first positioning frequency is advantageously 111.483 kHz or 134.5 kHz.

The second positioning frequency is advantageously 111.982 kHz or 136.0 kHz or 136.5 kHz.

The third positioning frequency is advantageously 112.994 kHz or 135.0 kHz.

The fourth positioning frequency is advantageously 113.507 kHz or 135.5 kHz or 136.0 kHz.

The fifth positioning frequency is advantageously 116.009 kHz or 135.5 kHz or 137.0 kHz or 137.5 kHz.

The respective motor vehicle, in particular the respective mobile induction charging device, advantageously comprises a correspondingly equipped receiver for receiving the alignment fields and/or the positioning fields. The receiver can comprise at least one receiver coil. Advantageously, the at least one receiver coil differs from the energy coil of the associated induction charging device.

The method is advantageously implemented by means of a computer program product.

The computer program product expediently contains instructions that result in the method being performed as described when executed on a computer system.

The computer program product is preferably stored at least partially in the respective motor vehicle, in particular in the respective mobile induction charging device.

The computer program product is preferably implemented at least partially in the respective motor vehicle, in particular in the respective mobile induction charging device. For this purpose, the motor vehicle, in particular the mobile induction charging device, can at least partially comprise the computer system. The computer system can at least partially be part of a control device of the motor vehicle, in particular of the mobile induction charging device.

It goes without saying that such a system is also part of the scope of this invention in addition to the method for operating the system.

Further important features and advantages of the invention are apparent from the dependent claims, from the drawings and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION TO THE DRAWINGS

The drawings show, each schematically, in

FIG. 1 a simplified plan view onto a system with a parking lot and motor vehicles,

FIG. 2 a cross-section through the stationary induction charging device of the parking lot,

FIG. 3 a cross-section through the stationary induction charging device in another exemplary embodiment,

FIG. 4 a simplified plan view onto the system in another exemplary embodiment,

FIG. 5 a simplified plan view onto the system in a further exemplary embodiment.

### DETAILED DESCRIPTION

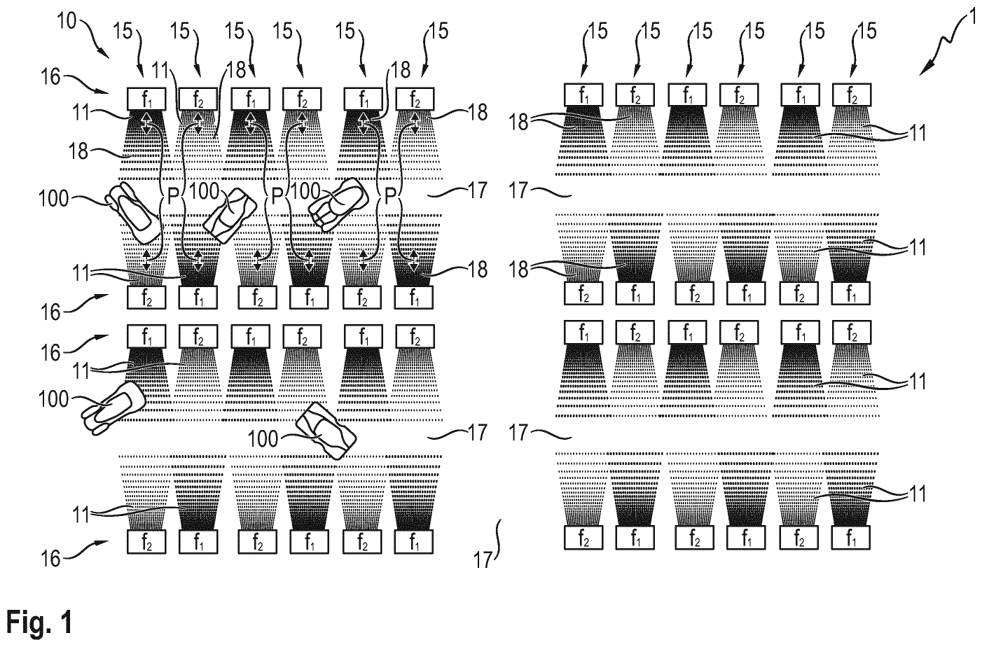

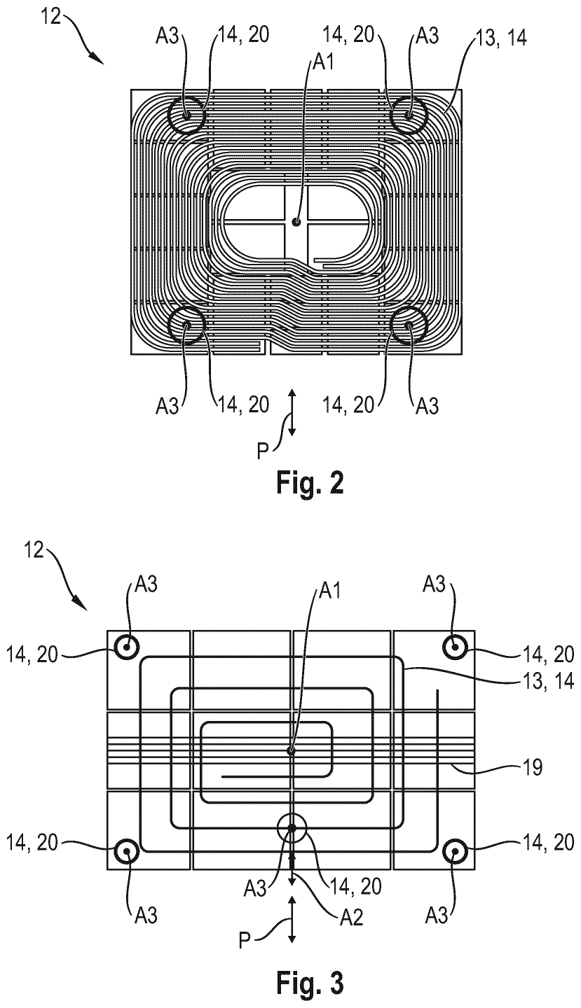

A system 1, as shown by way of example in FIGS. 1, 4 and 5, comprises a parking lot 10 and at least one motor vehicle 100. The parking lot 10 comprises at least four parking spaces 11, and a plurality of parking spaces 11 in the shown exemplary embodiments. The respective parking space 11 can be driven into along a direction P, which is hereinafter also referred to as parking direction P. The respective parking space 11 is provided with a stationary induction charging device 12 shown in FIGS. 2 and 3. The stationary induction charging device 12 can be arranged on the parking space 11 or at least partially embedded in the parking space 11. The respective stationary induction charging device 12 is used for wireless, inductive energy transfer with a motor vehicle 100. For this purpose, the respective motor vehicle 100 comprises a not shown mobile induction charging device, with which the stationary induction charging device 12 interacts inductively.

Such a stationary induction charging device 12 is shown in FIGS. 2 and 3. The respective stationary induction charging device 12 comprises an energy coil 13 for energy transfer with a mobile induction charging device. In the exemplary embodiments shown, the energy coil 13 is adapted as a flat coil 14. The respective energy coil 13 is wound about a winding axis A 1 oriented in parallel to the normal of the parking space 11.

As can be seen in FIGS. 1 and 4 and 5, at least two of the parking spaces 11 are arranged in a lengthwise row 15 oriented in parallel to the parking direction P and spaced apart from one another. Furthermore, at least two of the parking spaces 11 are arranged in a transverse row 16 oriented perpendicular to the parking direction P. In the exemplary embodiments shown, the respective parking space 11 is arranged in such a lengthwise row 15 and transverse row 16. As can further be seen from the figures, a traveling lane 17 of the parking lot 10 can be located between two consecutive transverse rows 16.

As indicated in FIGS. 1 and 4 and 5, the respective stationary induction charging device 12, which is not shown in these figures, generates a field directed in parking direction P, which is hereinafter also referred to as an alignment field 18, in order to align a mobile induction charging device in relation to the stationary induction charging device 12. The alignment field 18 oriented in parking direction P is indicated in FIGS. 1 and 4 and 5 by a correspondingly asymmetrical representation of the respective alignment field 18 in parking direction P. In the shown exemplary embodiment, the respective stationary induction charging device 12 generates a magnetic alignment field 18. For this purpose, the respective stationary induction charging device 12 comprises in the exemplary embodiments shown—as only shown in FIG. 3—a coil 19, which is hereinafter also referred to as alignment coil 19. In the exemplary embodiments shown, the alignment coil 19 is wound about a winding axis A2 oriented parallel to the parking direction P.

As can further be seen in FIGS. 1 and 4 and 5, the induction charging devices 12 of the parking spaces 11 of at least one of the transverse rows 16 alternately generate the alignment field 18 with a first frequency and a second frequency, which are hereinafter also referred to as the first alignment frequency and the second alignment frequency. In FIGS. 1 and 4 and 5, the particular parking spaces 11 whose stationary induction charging devices 12 generate the alignment field 18 with the first alignment frequency are labeled with “f1” and the particular parking spaces 11 whose stationary induction charging devices 12 generate the alignment field 18 with the second alignment frequency are labeled with “f2”. The different alignment frequencies are also indicated with a different representation of the alignment fields 18.

The respective motor vehicle 10 can receive the alignment fields 18 such that the motor vehicle 10 recognizes the local signal strength and the alignment frequency of the alignment fields 18. As a parking space 11 is approached, as shown in FIGS. 1, 4 and 5 for motor vehicles 100, the fact that the mobile induction charging device is to be aligned with the stationary induction charging device 12 associated with the parking space 1 lit is recognized on the basis of the stronger alignment field 18 and the alignment frequency of the stronger alignment field 18. Furthermore, a navigation instruction for aligning the motor vehicle 100 on the parking space 11 is output by means of the alignment field 18 associated with the approached parking space 11. In the exemplary embodiments shown, the respective alignment field 18 is used for far positioning a mobile induction charging device (not shown) in relation to the stationary induction charging device 12 associated with the approached parking space 11. This means in particular that the mobile induction charging device is positioned by means of the respective alignment field 18 in relation to the stationary induction charging device 12 associated with the parking space 11 for distances greater than 0.5 m, in particular for distances between 1.5 and meter and 0.5 m.

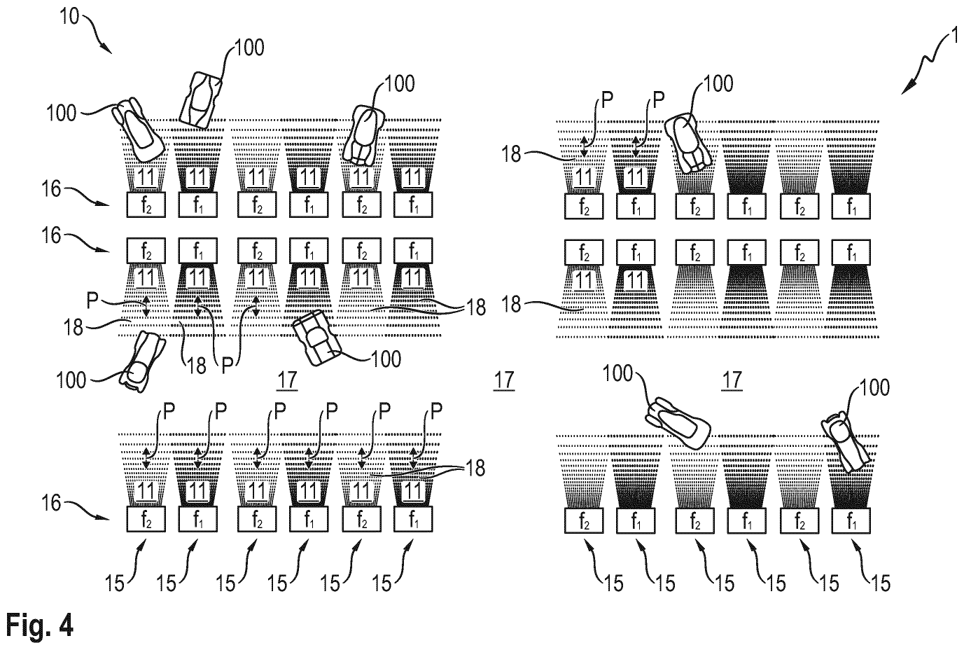

In the exemplary embodiments of FIGS. 1 and 4, the stationary induction charging devices 12 of the parking spaces 11 of the respective transverse row 16 alternately generate the alignment field 18 with the first alignment frequency and the second alignment frequency. The stationary induction charging devices 12 of the parking spaces 11 of the lengthwise row 15 thus generate the alignment field 18 with the same alignment frequency. The exemplary embodiments of FIGS. 1 and 4 differ in that the parking lot 10 in the exemplary embodiment of FIG. 1 comprises four transverse rows 16 and twelve lengthwise row 15 of the parking spaces 11, and the parking lot 10 in the exemplary embodiment of FIG. 4 comprises three transverse rows 16 and twelve lengthwise row 15 of the parking spaces 11. A traveling lane 17 is located centrally between the lengthwise rows 15.

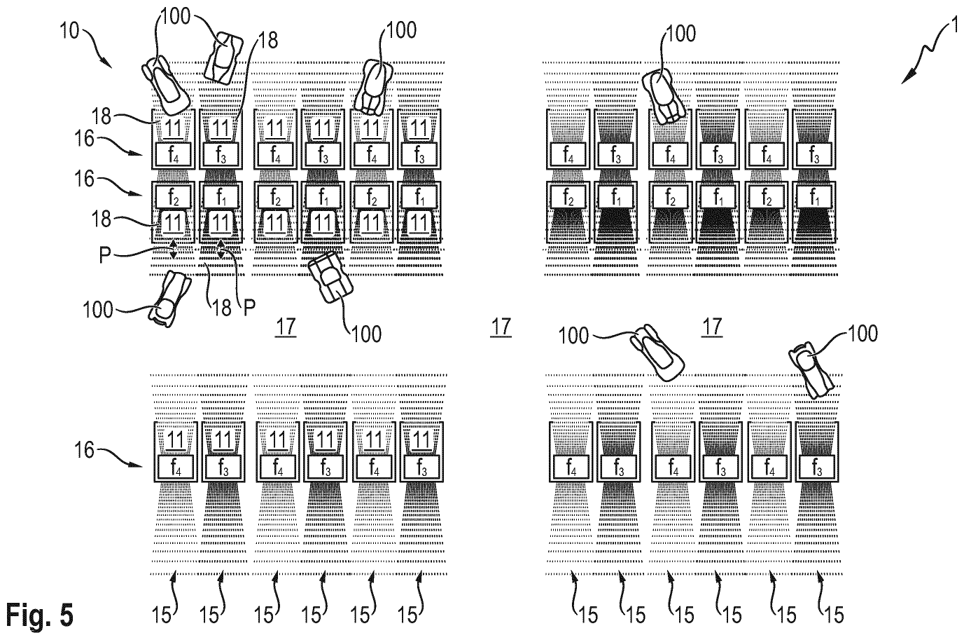

As can be seen in FIG. 5, the stationary induction charging devices 12 of the parking spaces 11 can generate the alignment field 18 along the transverse rows 16 and along the lengthwise rows 17, each with alternating alignment frequencies such that the stationary induction charging devices 12 of the parking spaces 11 alternately generate the alignment field with the first alignment frequency and the second alignment frequency in one of the transverse rows 16 and the stationary induction charging devices 12 of the parking spaces 11 alternately generate the alignment field 18 with a third alignment frequency and a fourth alignment frequency in the respectively adjacent transverse row 15. In FIG. 5, the particular parking spaces 11 whose stationary induction charging devices 12 generate the alignment field 18 with the third alignment frequency are labeled with “f3” and the particular parking spaces 11 whose stationary induction charging devices 12 generate the alignment field 18 with the fourth alignment frequency are labeled with “f4”. As can further be seen in FIG. 5, the first to fourth alignment frequency causes the stationary induction charging devices 12 of the parking spaces 11 to generate the alignment field 18 in the respective lengthwise row 15, either alternating with the first alignment frequency and the third alignment frequency or with the second alignment frequency and the fourth alignment frequency. In this case, the parking lot 10 in FIG. 5 has three transverse rows 16 and twelve lengthwise rows 15 of the parking spaces 11, as shown in FIG. 4 strictly by way of example.

For the sake of clarity, only the inwardly oriented halves of the alignment fields 18 are shown in FIG. 1 and FIG. 4 for the lowermost transverse rows 16 and for the outermost transverse rows 16. For the sake of clarity, FIG. 5 shows only half of the respective alignment field 18 with the first alignment frequency and the respective alignment field 18 with the second alignment frequency.

As can be seen in FIGS. 1 and 4 and 5, the respective alignment field 18 propagates from the associated stationary induction charging device 12 along the associated parking direction P. The respective motor vehicle 100 can thus also approach the respective parking space 11 at an incline in relation to the parking direction P and can nevertheless receive the corresponding alignment field 18.

In the exemplary embodiments shown, the respective stationary induction charging device 12 also generates a field that radiates from the plane of the associated parking space 11 and is hereinafter also referred to as a positioning field. In the exemplary embodiments shown, the positioning field serves for near positioning of a mobile induction charging device of a motor vehicle 100 in relation to the stationary induction charging device 12 following the far positioning. The respective motor vehicle 100 then receives the positioning field. A navigation instruction for positioning the mobile induction charging device of the motor vehicle 100 in relation to the stationary induction charging device 12 of the approached parking space 11 is output by means of the positioning field.

As shown in FIGS. 2 and 3, the respective stationary induction charging device 12 comprises either four or five coils 20 spaced apart from one another for generating the associated positioning field, which are hereinafter also referred to as positioning coils 20. The respective positioning coil 20 generates a magnetic field such that the respective positioning field consists of four or five magnetic fields offset in relation to one another. In the exemplary embodiment of FIG. 2, the stationary induction charging device 12 comprises four positioning coils 20 such that the generated positioning field consists of four magnetic fields. In the exemplary embodiment of FIG. 3, the stationary induction charging device 12 comprises five positioning coils 20 such that the generated positioning field comprises the five magnetic fields. In the exemplary embodiments shown, the respective positioning transmitter coil 20 is a flat coil 14 wound about a winding axis A3 oriented parallel to the normal of the parking space 11. The respective magnetic field of the positioning field is generated with an associated frequency, which is hereinafter also referred to as the positioning frequency. In the exemplary embodiment of FIG. 4, the positioning field therefore comprises a magnetic field with a first positioning frequency, a magnetic field with a second positioning frequency, a magnetic field with a third positioning frequency, and a magnetic field with a fourth positioning frequency. In the exemplary embodiment of FIG. 3, the positioning field comprises a magnetic field having a first positioning frequency, a magnetic field having a second positioning frequency, a magnetic field having a third positioning frequency, a magnetic field having a fourth positioning frequency, and a magnetic field having a fifth positioning frequency.

The respective frequency is in the kilohertz range in the exemplary embodiments shown. Additionally, in the exemplary embodiments shown, the respective positioning frequency differs from the respective alignment frequency of the respective alignment field. Furthermore, the magnetic fields of the positioning field of the respective stationary induction charging device 12 are generated with the same positioning frequencies in the exemplary embodiments shown.

For example, the first alignment frequency is 134.0 kHz or 135.0 kHz or 145.560 kHz, the second alignment frequency is 135.5 kHz or 136.5 kHz or 137.0 kHz or 145.985 kHz, the third alignment frequency is 133.5 kHz or 146.843 kHz, the fourth alignment frequency is 137.0 kHz or 137.5 kHz or 147.275. For example, the first positioning frequency is 111.483 kHz or 134.5 kHz, the second positioning frequency is 111.982 kHZ or 136.0 kHz or 136.5 kHz, the third positioning frequency is 112.994 kHz or 135.0 kHz, the fourth positioning frequency is 113.507 kHz or 135.5 kHz or 136.0 kHz, and the fifth positioning frequency is 116.009 kHz or 135.5 kHz or 137.0 kHz or 137.5 kHz.

1-16. (canceled)

17. A motor vehicle, comprising a mobile induction charging device, wherein the motor vehicle is configured to:
receive alignment fields generated by stationary induction charging devices of parking spaces of a parking lot and to detect the signal strength and alignment frequency of the alignment fields,
recognize based on a stronger alignment field and the alignment frequency of the stronger alignment field that the mobile induction charging device is to be aligned with the stationary induction charging device associated with the parking space as it approaches one of the parking spaces, and
output a navigation instruction for aligning the motor vehicle on the parking space via the alignment field associated with the approached parking space.

18. The motor vehicle according to claim 17, wherein the motor vehicle is further configured to:
receive a positioning field generated by one of the stationary induction charging devices, and
output via the positioning field a navigation instruction for positioning the mobile induction charging device in relation to the stationary induction charging device of the approached parking space.

19. The motor vehicle according to claim 18, wherein a near positioning of the mobile induction charging device in relation to the induction charging device associated with the approached parking space is carried out via the positioning field.

20. A method for operating a motor vehicle with a mobile induction charging device in a parking lot, comprising:
receiving alignment fields generated by stationary induction charging devices of parking spaces of the parking lot, and detecting a signal strength and alignment frequency of the alignment fields,
as one of the parking spaces is approached, detecting based on a stronger alignment field and the alignment frequency of the stronger alignment field that the mobile induction charging device is to be aligned with the stationary induction charging device associated with the parking space, and
via the alignment field associated with the approached parking space, outputting a navigation instruction for aligning the motor vehicle on the parking space.

21. The method according to claim 20, further comprising:
receiving a positioning field generated by one of the induction charging devices, and
via the positioning field, outputting a navigation instruction for positioning the mobile induction charging device to the stationary induction charging device of the approached parking space.

22. The method according to claim 21, wherein a near positioning of the mobile induction charging device in relation to the induction charging device associated with the approached parking space is carried out via the positioning field.

23. A parking lot, comprising:
at least one first parking space and a second parking space, wherein:
the first parking space can be driven into in a first parking direction, the first parking space is provided with a first stationary induction charging device configured to cooperate with a mobile induction charging device of a motor vehicle for wireless energy transfer, and
the second parking space can be driven into in a second parking direction, the second parking space is provided with a second stationary induction charging device configured to cooperate with the mobile induction charging device of the motor vehicle for wireless energy transfer, wherein the first stationary induction charging device is configured to generate a first alignment field directed in the first parking direction with a first alignment frequency for aligning the mobile induction charging device with the first stationary induction charging device, and
the second stationary induction charging device is configured to generate a second alignment field directed in the second parking direction with a second alignment frequency for aligning the mobile induction charging device with the first second stationary induction charging device.

24. The parking lot according to claim 23, wherein the first stationary induction charging device and/or the second stationary induction charging device is configured to generate a magnetic alignment field.

25. The parking lot according to claim 23, wherein at least one of the alignment fields propagates along the associated parking direction starting from the associated stationary induction charging device.

26. The parking lot according to claim 23, wherein the first alignment field and/or the second alignment field is used for far positioning the mobile induction charging device in relation to the stationary induction charging device associated with the approached parking space.

27. The parking lot according to claim 23, wherein the first stationary induction charging device and/or the second stationary induction charging device is configured to generate a positioning field directed parallel in relation to a normal of the associated parking space.

28. The parking lot according to claim 27, wherein the first stationary induction charging device and/or the second stationary induction charging device is configured to generate the positioning field from four or five magnetic fields offset in relation to one another.

29. The parking lot according to claim 28, wherein the four or five magnetic fields of the positioning field are respectively generated with an associated positioning frequency such that the positioning field:
is comprised of a magnetic field having a first positioning frequency, a magnetic field having a second positioning frequency, a magnetic field having a third positioning frequency, and a magnetic field having a fourth positioning frequency, or
is comprised of a magnetic field having a first positioning frequency, a magnetic field having a second positioning frequency, a magnetic field having a third positioning frequency, a magnetic field having a fourth positioning frequency, and a magnetic field having a fifth positioning frequency.

30. The parking lot according to claim 29, wherein the respective positioning frequency differs from the respective alignment frequency of the respective alignment field.

31. The parking lot according to claim 29, wherein the magnetic fields of the positioning field of the respective stationary induction charging device are generated with the same positioning frequencies.

32. The parking lot according to claim 23, wherein the first alignment frequency is 134.0 kHz or 135.0 kHz or 145.560 kHz and the second alignment frequency is 135.5 kHz or 136.5 kHz or 137.0 kHz or 145.985 kHz.

33. The parking lot according to claim 23, further comprising
a third parking space and a fourth parking space, wherein:
the third parking space can be driven into in a third parking direction, the third parking space is provided with a third stationary induction charging device configured to cooperate with the mobile induction charging device of the motor vehicle for wireless energy transfer and to generate an alignment field with a third alignment frequency directed in the third parking direction for the alignment of the mobile induction charging device to the third stationary induction charging device, and
the fourth parking space can be driven into in a fourth parking direction, the fourth parking space is provided with a fourth stationary induction charging device configured to cooperate with the mobile induction charging device of the motor vehicle for wireless energy transfer and to generate an alignment field with a fourth alignment frequency directed in the fourth parking direction for the alignment of the mobile induction charging device to the fourth stationary induction charging device, wherein the third alignment frequency is 133.5 kHz or 146.843 kHz and the fourth alignment frequency is 137.0 kHz or 137.5 kHz or 147.275 kHz.

34. The parking lot according to claim 33, wherein the first parking space and the third parking space are arranged in a lengthwise row oriented parallel in relation to the first parking direction, the first parking space and the second parking space of a first transverse row are arranged oriented transversely in relation to the first parking direction, and the third parking space and the fourth parking space are arranged in a second transverse row adjacent to the first transverse row.

35. The parking lot according to claim 29, wherein:
the first positioning frequency is 111.483 kHz or 134.5 kHz,
the second positioning frequency is 111.982 kHz or 136.0 kHz or 136.5 kHz,
the third positioning frequency is 112.994 kHz or 135.0 kHz,
the fourth positioning frequency is 113.507 kHz or 135.5 kHz or 136.0 kHz, or
the first positioning frequency is 111.483 kHz or 134.5 kHz,
the second positioning frequency is 111.982 kHz or 136.0 kHz or 136.5 kHz,
the third positioning frequency is 112.994 kHz or 135.0 kHz,
the fourth positioning frequency is 113.507 kHz or 135.5 kHz or 136.0 kHz,
the fifth positioning frequency is 116.009 kHz or 135.5 kHz or 137.0 kHz or 137.5 kHz.

36. A method for operating a parking lot according to claim 23.
